(19) United States
(12) Patent Application Publication
(10) Pub. No.: US 2011/0181691 A1
(43) Pub. Date: Jul. 28, 2011

(54) System and method for decoding and de-interlacing CVBS signal

(75) Inventors: Chian-Wen Chen, Taipei City (TW); Tsung-Hang Chiang, Kaohsiung City (TW)

(73) Assignee: Sunplus Technology Co., Ltd., Hsinchu (TW)

(21) Appl. No.: 12/805,719

(22) Filed: Aug. 17, 2010

(30) Foreign Application Priority Data
Jan. 27, 2010 (TW) 099102234

(51) Int. Cl. H04N 13/00

(52) U.S. Cl. 348/43; 348/E13.062; 348/E13.073

(57) ABSTRACT

A system for decoding and de-interlacing CVBS signal includes a 2D luminance and chrominance separator, a chrominance to color difference converter, a synchronization and scaling device, a storage and a 3D luminance and chrominance separation, de-noise and de-interlacing device. The 2D luminance and chrominance separator generates 2D luminance and chrominance signals based on sampled CVBS signal. The chrominance to color difference converter converts the 2D chrominance signal into 2D color difference signal. The synchronization and scaling device synchronizes the sampled CVBS signal, 2D luminance signal, and 2D color difference signal for generating synchronized CVBS signal, synchronized 2D luminance signal, and synchronized 2D color difference signal. The storage buffers the synchronized CVBS signal, synchronized 2D luminance signal, and synchronized 2D color difference signal. The 3D luminance and chrominance separation, de-noise and de-interlacing device performs 3D luminance and chrominance separation, de-noise and de-interlacing operation for generating a frame.

### BACKGROUND OF THE INVENTION

1. Field of the Invention

The present invention relates to the technical field of image processing and, more particularly, to a system and method for decoding and de-interlacing Color Video, Blanking, and Synchronization (CVBS) signal.

2. Description of Related Art

Current television (TV) signals are transmitted by mixing luminance and chrominance signals into a carrier to thereby have the advantage of being capable of receiving the same signal for the black-and-white TV set and the color TV set, which is particularly necessary when black-and-white TV sets were being replaced with color TV sets.

As shown in FIG. 1, a composite signal contains a luminance signal and a chrominance signal. For a Nation Television System Committee (NTSC) system, the center frequency of a chrominance signal is at 3.58 MHz, and for a Phase Alternation Line (PAL) system, the center frequency is at 4.43 MHz. When a video decoder receives a composite signal, it performs a luminance/chrominance (Y/C) separation to thereby separate the luminance signal and the chrominance signal for further processing.

FIG. 2 is a schematic diagram of a typical 2D luminance and chrominance separator. As shown in FIG. 2, the separator has a notch filter to suppress the chrominance signal to thereby obtain the luminance signal, and a bandpass filter to obtain the chrominance signal. In this case, since the chrominance signal is transmitted by a 3.58 MHz (MTSC) or 4.43 MHz (PAL) carrier with the luminance signal, the high-frequency component of the luminance signal and the chrominance signal occupy the same spectrum. Accordingly, the component of the luminance signal may be mistakenly treated as the chrominance signal, even the notch filter and the bandpass filter are used, resulting in the serious cross-color effect. Also, a component of the chrominance signal can be mistakenly treated as the luminance signal to thus cause the serious cross-luminance effect.

Since the luminance and chrominance signals are superimposed, a part of the carrier cannot be separated accurately, and the luminance and chrominance cannot be restored accurately, resulting in having defects shown on a picture. For example, when a luminance component is mistakenly treated as a chrominance component in processing, rainbow colors, also known as a cross-color artifact, are present on a picture. Conversely, when a chrominance component is mistakenly treated as a luminance component in processing, horizontal or vertical dotted lines, also known as a cross-luminance artifact, are present. To overcome this problem, a 3D Y/C separation is applied to the composite signal to thereby separate the luminance and chrominance.

Noises caused at a TV signal transmission can be filtered out by a de-noise technology to thereby reduce the degree of snow effect produced on a TV picture or eliminate the residual image effect on a TV motion picture.

In order to reduce the flicker on a picture and the required bandwidth for a data transmission, an interlaced scanning is widely used in a conventional TV set. However, due to some inherent defects of such an interlaced scanning, the fine parts of a picture may easily present some poor visional effects such as line flicker and jitter. With the advance of technologies in recent years, LCD TVs have developed rapidly. In addition, for achieving a high quality image, digital TVs can support the progressive scan pictures to thereby increase the picture quality. Accordingly, a de-interlacing is applied to a digital TV for converting a typical interlaced scan format picture into a progressive scan picture.

FIG. 3 is a block diagram of a typical system for decoding and de-interlacing CVBS signal. As shown in FIG. 3, the 2D luminance and chrominance separator 310 and the 3D luminance and chrominance separator 320 respectively receive a composite signal CVBS4. The composite signal CVBS4 corresponding to a field field4 is used to perform a 2D luminance and chrominance separation and a 3D luminance and chrominance separation to thereby produce a 2D luminance and a 2D chrominance signals 2D Y4, 2D C4 and a 3D luminance and a 3D chrominance signals 3D Y4, 3D C4, respectively.

For performing the 3D luminance and chrominance separation on the composite signal CVBS4, the 3D luminance and chrominance separator 320 reads a composite signal CVBS0 pre-stored and corresponding to the field field4 from the storage 330 in order to calculate a motion ratio for the composite signal CVBS4 (field4), and writes the motion ratio in the storage 330. Next, the separator 320 writes the composite signal CVBS4 in the storage 330 to thereby replace the composite signal CVBS0.

The mixture and chrominance to color difference converter 340 mixes the signals 2D Y4, 2D C4, 3D Y4, 3D C4 and converts the chrominance signal into a color difference signal UV4 to thereby output a signal (Y4, UV4). The signal (Y4, UV4) corresponding to the field field4 has an active region. The synchronizer 350 extracts a signal Y4UV4′ corresponding to the active region from the signal (Y4, UV4). The 3D noise eliminator 360 eliminates noises in the signal Y4UV4′ and produces a de-noise signal Y4UV4″. The 3D de-interlacer 370 reads the de-noise signals Y2UV2″, Y1UV1″, Y0UV0″ from the storage 330 in order to perform a de-interlacing operation to thereby produce a frame centered on the field field1.

The 3D de-noise eliminator 360 writes the signal Y4UV4″ in the storage 330 to replace the signal Y0UV0″ while the 3D de-interlacer 370 reads the signal Y0UV0″ out of the storage 330.

In the system for decoding and de-interlacing CVBS signal, the 3D luminance and chrominance separator 320 requires the motion ratio for performing the luminance and chrominance separation, and the 3D de-interlacer 370 requires the motion ratio corresponding to a working field for performing a de-interlacing operation. Thus, the storage 330 requires more space to accordingly store the motion ration respectively for the separator 320 and the de-interlacer 370. In addition, the storage 330 requires additional space to store the CVBS signals for the separator 320 and the de-noise signals for the de-interlacer 370. When the field resolution is increased, the required space of the storage 330 is increased to thereby add much hardware cost.

Therefore, it is desirable to provide an improved method to mitigate and/or obviate the aforementioned problems.

### SUMMARY OF THE INVENTION

The object of the present invention is to provide a system and method for decoding and de-interlacing Color Video, Blanking, and Synchronization (CVBS) signal, which can reduce the used memory amount and the data rate of memory access to thereby reduce the memory access bandwidth, the entire system clock frequency, and the entire system power consumption.

In accordance with one aspect of the invention, there is provided a system for decoding and de-interlacing CVBS signal. The system includes a 2D luminance and chrominance separator, a chrominance to color difference converter, a synchronization and scaling device, a storage, and a 3D luminance and chrominance separation, de-noise and de-interlacing device. The 2D luminance and chrominance separator receives a sampled CVBS signal corresponding to a field to thereby generate a 2D luminance signal and a 2D chrominance signal. The chrominance to color difference converter is connected to the 2D luminance and chrominance separator in order to convert the 2D chrominance signal into a 2D color difference signal. The synchronization and scaling device is connected to the 2D luminance and chrominance separator in order to receive the sampled CVBS signal to thereby perform a synchronization operation on the sampled CVBS signal, the 2D luminance signal, and the 2D color difference signal for generating a synchronized CVBS signal, a synchronized 2D luminance signal, and a synchronized 2D color difference signal respectively. The storage is connected to the synchronization and scaling device in order to temporarily store the synchronized CVBS signal, the synchronized 2D luminance signal, and the synchronized 2D color difference signal. The 3D luminance and chrominance separation, de-noise and de-interlacing device is connected to the synchronization and scaling device and the storage in order to perform a 3D luminance and chrominance separation, de-noise and de-interlacing operation to thereby generate a frame.

In accordance with another aspect of the invention, there is provided a method for decoding and de-interlacing CVBS signal. The method includes the steps of (A) receiving a sampled CVBS signal corresponding to a field; (B) using a 2D luminance and chrominance separator to extract a 2D luminance signal and a 2D chrominance signal from the sampled CVBS signal; (C) using a chrominance to color difference converter to convert the 2D chrominance signal into a 2D color difference signal; (D) using a synchronization and scaling device to perform a synchronization operation on the sampled CVBS signal, the 2D luminance signal, and the 2D color difference signal for generating a synchronized CVBS signal, a synchronized 2D luminance signal, and a synchronized 2D color difference signal, respectively; (E) using a 3D luminance and chrominance separator to separate and generate a 3D luminance signal and a 3D color difference signal based on the synchronized CVBS signal, the synchronized 2D color difference signal, and a previous synchronized CVBS signal; (F) using a mixer to mix the synchronized 2D luminance signal, the synchronized 2D color difference signal, the 3D luminance signal, and the 3D color difference signal based on a motion ratio to thereby generate a mixed field signal; (G) using a noise eliminator to perform a de-noise operation based on the mixed field signal and a previous mixed field signal to thereby generate a de-noise field signal; and (H) using a de-interlacer to perform a de-interlacing operation based on the de-noise field signal and a previous de-noise field signal to thereby generate a de-interlaced frame.

Other objects, advantages, and novel features of the invention will become more apparent from the following detailed description when taken in conjunction with the accompanying drawings.

### BRIEF DESCRIPTION OF THE DRAWINGS

FIG. 1 is a schematic graph of a typical composite signal;

FIG. 2 is a schematic diagram of a typical 2D luminance and chrominance separator;

FIG. 3 is a block diagram of a typical system for decoding and de-interlacing a CVBS signal;

FIG. 4 is a block diagram of a system for decoding and de-interlacing a Color Video, Blanking, and Synchronization (CVBS) signal according to the invention;

FIG. 5 is a schematic diagram of an operation of a synchronization and scaling device according to the invention;

FIG. 6 is a schematic diagram of an access to a storage according to the invention;

FIG. 7 is a schematic diagram of another access to a storage according to the invention;

FIG. 8 is a block diagram of a mixer according to the invention;

FIG. 9 is a flowchart of a method for decoding and de-interlacing a Color Video, Blanking, and Synchronization (CVBS) signal according to the invention;

FIG. 10 is a timing of a typical system for decoding and de-interlacing a CVBS signal;

FIG. 11 is a timing of a system for decoding and de-interlacing a CVBS signal according to the invention; and

FIG. 12 is a comparison table of a storage space used by the prior art and the invention.

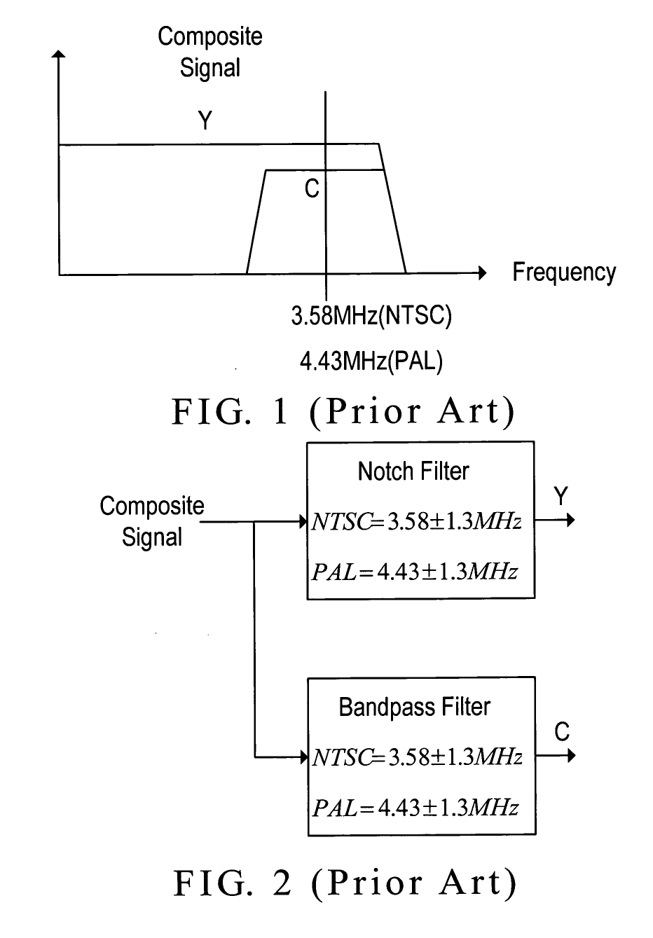

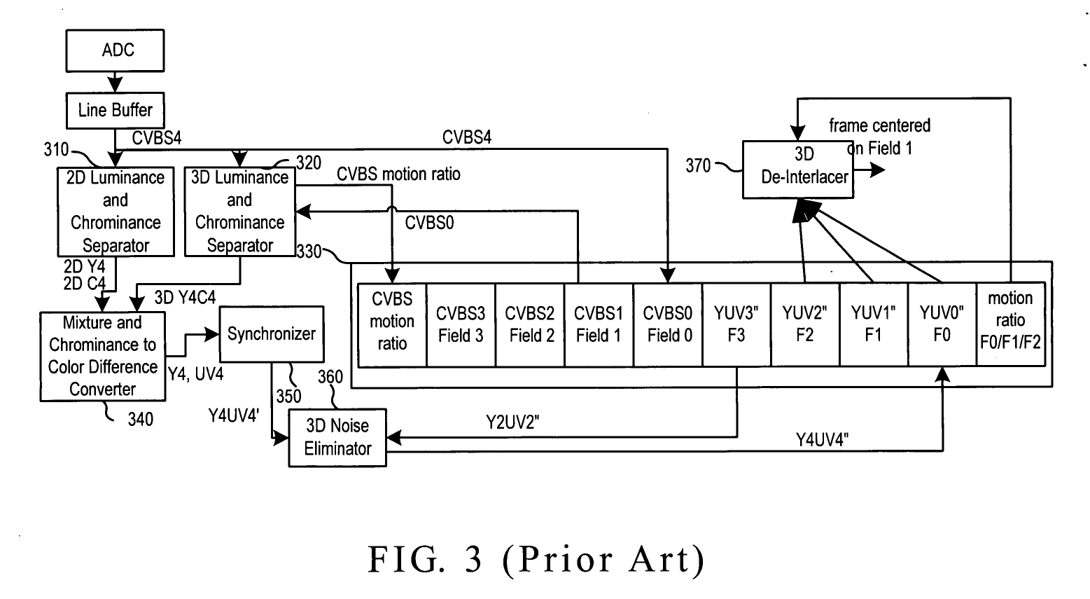

### DETAILED DESCRIPTION OF THE PREFERRED EMBODIMENT

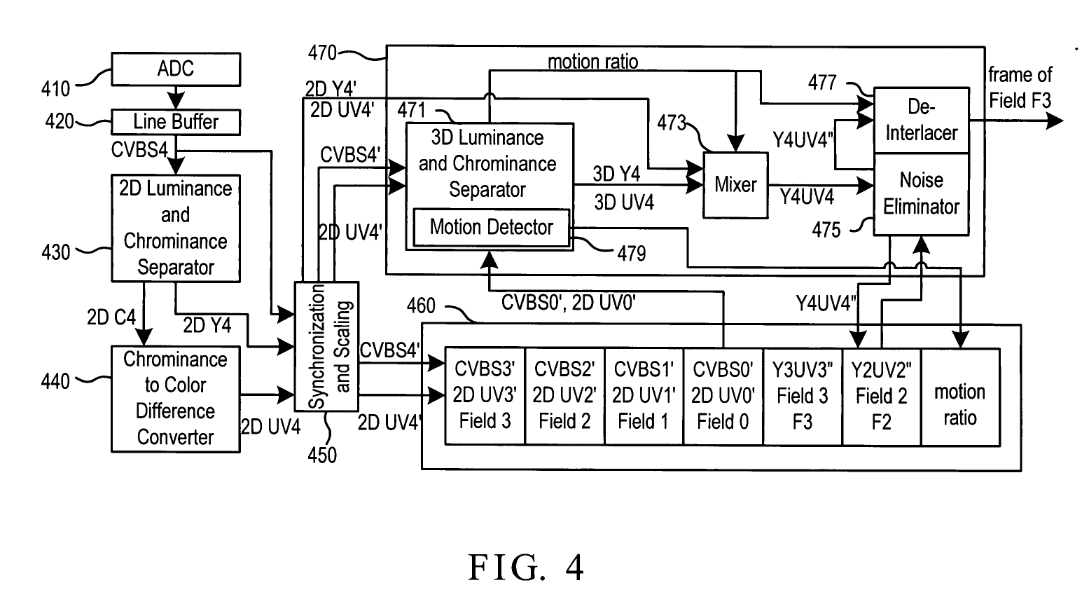

FIG. 4 is a block diagram of a system for decoding and de-interlacing Color Video, Blanking, and Synchronization (CVBS) signal in accordance with the invention. In FIG. 4, the system includes an analog to digital converter (ADC) 410, a line buffer 420, a 2D luminance and chrominance separator 430, a chrominance to color difference converter 440, a synchronization and scaling device 450, a 3D luminance and chrominance separation, de-noise and de-interlacing device 470.

The ADC 410 receives and samples an analog CVBS signal, and converts it into a digital form to thereby produce a sampled CVBS signal CVBS4. The sampled CVBS signal CVBS4 corresponds to a field F4.

The line buffer 420 is connected to the ADC 410 and the 2D luminance and chrominance separator 430 in order to temporarily store the sampled CVBS signal.

The 2D luminance and chrominance separator 430 is connected to the line buffer 420 in order to receive a sampled CVBS signal to thereby extract a 2D luminance signal (2D Y4) and a 2D chrominance signal (2D C4) from the sampled CVBS signal.

The chrominance to color difference converter 440 is connected to the 2D luminance and chrominance separator 430 in order to convert the 2D chrominance signal (2D C4) into a 2D color difference signal (2D UV4).

The synchronization and scaling device 450 is connected to the line buffer 410, the 2D luminance and chrominance separator 430, and the chrominance to color difference converter 440 in order to receive the sampled CVBS signal (CBVS4) of the line buffer 410, the 2D luminance signal (2D Y4) of the separator 430, and the 2D color difference signal (2D UV4) of the converter 440 to thereby perform a synchronization operation on the sampled CVBS signal (CVBS4), the 2D luminance signal (2D Y4), and the 2D color difference signal (2D UV4) for generating a synchronized CVBS signal (CVBS4′), a synchronized 2D luminance signal (2D Y4′), and a synchronized 2D color difference signal (2D UV4′) respectively.

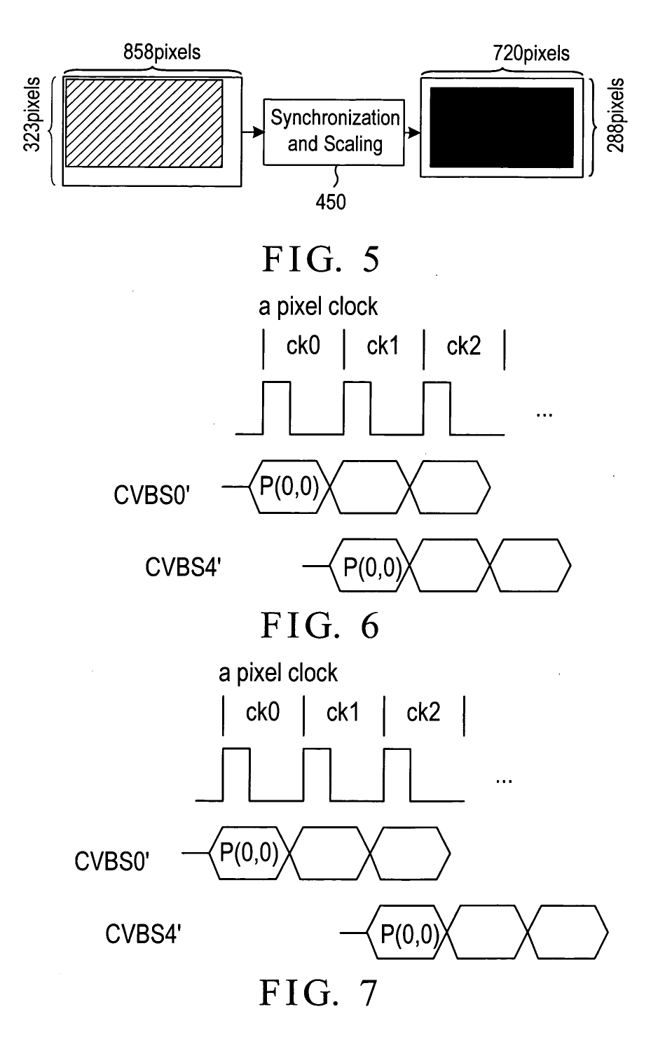

FIG. 5 is a schematic diagram illustrating the operation of the synchronization and scaling device 450 in accordance with the invention. As shown in FIG. 5, in the NTSC or PAL standard, an active region is defined. However, in an NTSC or PAL signal coding, the NTSC or PAL signals produced by different manufacturers may have some errors or deformations due to the limited bandwidth of a transmission medium or the active region offset caused by the noises in transmission. The synchronization and scaling device 450 is based on the sampled CVBS signal (CBVS4), the 2D luminance signal (2D Y4), and the 2D color difference signal (2D UV4) to find the active region in the field F4 and to correct the offset active region, and based on the sampled CVBS signal (CBVS4) and a predetermined display picture resolution to perform a scaling operation to thereby produce a synchronized CVBS signal (CVBS4′), a synchronized 2D luminance signal (2D Y4′), and a synchronized 2D color difference signal (2D UV4′).

The horizontal and vertical blanking pixels in the field F4 are not used in the subsequent operations, and in this case the synchronization and scaling device 450 eliminates the horizontal and vertical blanking pixels in the field F4 to thereby reduce the data amount. As shown in FIG. 5, the resolution of the field F4 is reduced from 858×323 to 720×288 after the horizontal and vertical blanking pixels are eliminated, and the stored data amount is thus reduced.

The storage 460 is connected to the synchronization and scaling device 450 in order to temporarily store the synchronized CVBS signal (CVBS4′), and the synchronized 2D color difference signal (2D UV4′). The line buffer 420 and the storage 460 can be integrated into a single memory.

The 3D luminance and chrominance separation, de-noise and de-interlacing device 470 is connected to the synchronization and scaling device 450 and the storage 460 in order to perform a 3D luminance and chrominance separation, de-noise and de-interlacing operation to thereby generate a frame centered on a field F3.

The 3D luminance and chrominance separation, de-noise and de-interlacing device 470 includes a 3D luminance and chrominance separator 471, a mixer 473, a noise eliminator 475, and a de-interlacer 477.

The 3D luminance and chrominance separator 471 is connected to the synchronization and scaling device 450 and the storage 460 in order to receive the synchronized CVBS signal (CVBS4′), the synchronized 2D color difference signal (2D UV4′) outputted by the synchronization and scaling device 450, and a previous synchronized CVBS signal stored in the storage for performing a 3D luminance and chrominance separation operation on the synchronized CVBS signal (CVBS4′) to thereby produce a 3D luminance signal (3D Y4) and a 3D color difference signal (3D UV4). The synchronization and scaling device 450 also stores the synchronized CVBS signal (CVBS4′) to the storage 460.

The 3D luminance and chrominance separator 471 includes a motion detector 479 connected to the synchronization and scaling device 450, the noise eliminator 475, and the de-interlacer 477. The motion detector 479 produces a motion ratio based on the synchronized CVBS signal (CVBS4′) outputted by the synchronization and scaling device 450, the 3D luminance signal (3D Y4), and the 3D color difference signal (3D UV4).

FIG. 6 is a schematic diagram illustrating an access to the storage 460 in accordance with the invention. As shown in FIG. 6, the 3D luminance and chrominance separator 471 reads the pixel (0,0) of the signal (CVBS0′) out at clock ck0, and the synchronization and scaling device 450 writes the pixel (0,0) of the signal (CVBS4′) in and stores it in the designated position at clock ck1. Accordingly, the storage 460 requires only storing the data amount of four fields (CVBS0′, CVBS1′, CVBS2′, CVBS3′). FIG. 7 is a schematic diagram illustrating another access to the storage 460 according to the invention, which is operated with a lower timing. Based on the same operation, an access to the synchronized 2D color difference signal (2D UV4′) is similar, and thus a detailed description is deemed unnecessary.

The mixer 473 is connected to the synchronization and scaling device 450 and the 3D luminance and chrominance separator 471 in order to mix the synchronized 2D luminance signal, the synchronized 2D color difference signal, the 3D luminance signal, and the 3D color difference signal based on the motion ratio to thereby generate a mixed field signal (Y4UV4).

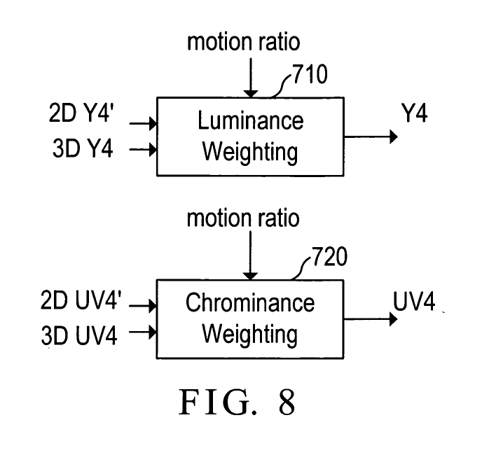

FIG. 8 is a block diagram of the mixer 473 in accordance with the invention. As shown in FIG. 8, the mixer 473 includes a luminance weighting device 710 and a chrominance weighting device 720.

The luminance weighting device 710 is connected to the synchronization and scaling device 450 and the 3D luminance and chrominance separator 471. When the motion ratio indicates that the corresponding pixel (i, j) is an absolute still point, the 3D luminance signal (3D Y4) is used as the luminance component (Y4) of the mixed field signal. When the motion ratio indicates that the corresponding pixel (i, j) is between the absolute still point and an absolute non-still point, a weighting operation is performed on the synchronized 2D luminance signal (2D Y4′) and the 3D luminance signal (3D Y4) to thereby produce the luminance component (Y4) of the mixed field signal. When the motion ratio indicates that the corresponding pixel (i, j) is the absolute non-still point, the synchronized 2D luminance signal (2D Y4′) is used as the luminance component (Y4) of the mixed field signal.

The chrominance weighting device 720 is connected to the synchronization and scaling device 450 and the 3D luminance and chrominance separator 471. When the motion ratio indicates that the corresponding pixel (i, j) is the absolute still point, the weighting operation is performed on the synchronized 2D color difference signal (2D UV4′) and the 3D color difference signal (3D UV4) to thereby produce the color difference component (UV4) of the mixed field signal. When the motion ratio indicates that the corresponding pixel (i, j) is the absolute non-still point, the synchronized 2D color difference signal (2D UV4′) is used as the color difference component (UV4) of the mixed field signal.

The noise eliminator 475 is connected to the mixer 473 and the storage 460 in order to perform a de-noise operation based on the mixed field signal (Y4UV4) outputted by the mixer 473 and a previous mixed field signal (Y2UV2″) stored in the storage 460 to thereby generate a de-noise field signal (Y4UV4″).

The de-interlacer 477 is connected to the 3D luminance and chrominance separator 471, the noise eliminator 475, and the storage 460 in order to perform a de-interlacing operation based on the de-noise field signal (Y4UV4″) outputted by the noise eliminator 475 and a previous de-noise field signal (Y3UV3″, Y2UV2″) stored in the storage 460 to thereby generate a de-interlaced frame signal (Y3UV3) centered on the field F3.

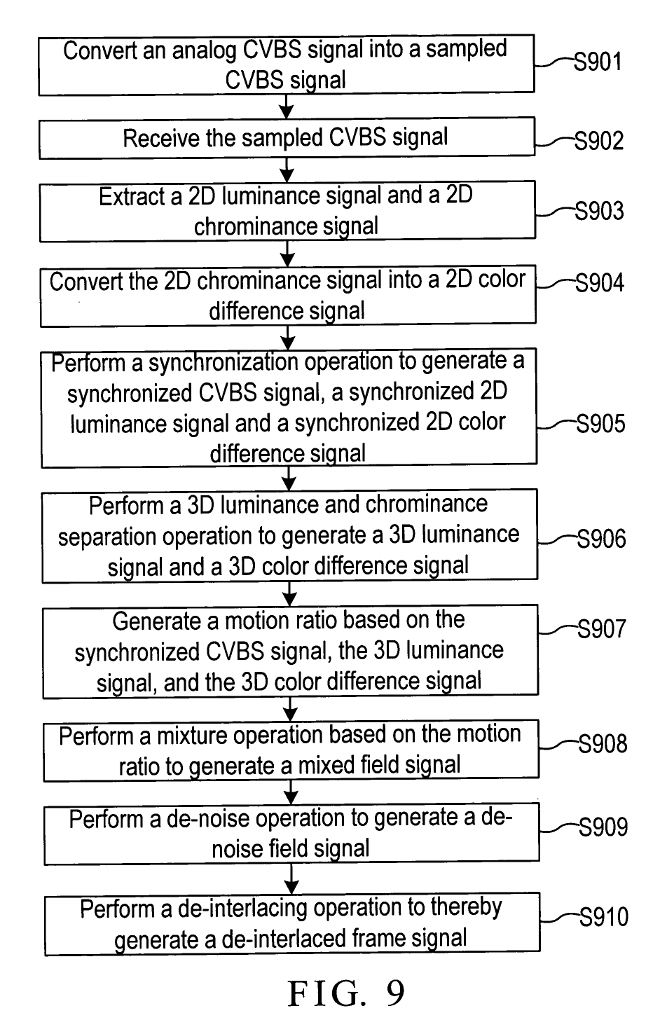

FIG. 9 is a flowchart of a method for decoding and de-interlacing Color Video, Blanking, and Synchronization (CVBS) signal in accordance with the invention. As shown in FIG. 9, step S901 uses an ADC to receive and sample an analog CVBS signal for converting the analog signal into a digital CVBS signal to thereby produce a sampled CVBS signal. Step S902 receives the sampled CVBS signal CVBS4 corresponding to a field F4.

Step S903 uses a two-dimensional (2D) luminance and chrominance separator 430 to extract a 2D luminance signal (2D Y4) and a 2D chrominance signal (2D C4) from the sampled CVBS signal (CVBS4).

Step S904 uses a chrominance to color difference converter 440 to convert the 2D chrominance signal (2D C4) into a 2D color difference signal (2D UV4).

Step S905 uses a synchronization and scaling device 450 to perform a synchronization operation on the sampled CVBS signal, the 2D luminance signal (2D Y4), and the 2D color difference signal (2D UV4) for generating a synchronized CVBS signal (CVBS4′), a synchronized 2D luminance signal (2D Y4′), and a synchronized 2D color difference signal (2D UV4′), respectively.

Step S906 uses a three-dimensional (3D) luminance and chrominance separator 471 to perform a 3D luminance and chrominance separation operation on the synchronized CVBS signal (CVBS4′) based on the synchronized CVBS signal (CVBS4′), the synchronized 2D color difference signal (2D UV4′), and a previous synchronized CVBS signal (CVBS0′) to thereby generate a 3D luminance signal (3D Y4) and a 3D color difference signal (3D UV4).

Step S907 uses a motion detector 479 to generate a motion ratio based on the synchronized CVBS signal (CVBS4′), the 3D luminance signal (3D Y4), and the 3D color difference signal (3D UV4).

Step S908 uses a mixer 473 to mix the synchronized 2D luminance signal (2D Y4′), the synchronized 2D color difference signal (2D UV4′), the 3D luminance signal (3D Y4), and the 3D color difference signal (3D UV4) based on a motion ratio to thereby generate a mixed field signal (Y4UV4).

Step S909 uses a noise eliminator 475 to perform a de-noise operation based on the mixed field signal (Y4UV4) and a previous mixed field signal (Y2UV2″) to thereby generate a de-noise field signal (Y4UV4″).

Step S910 uses a de-interlacer 477 to perform a de-interlacing operation based on the de-noise field signal (Y4UV4″) and previous de-noise field signal (Y3UV3″, Y2UV2″) to thereby generate a de-interlaced frame signal (Framed Y3UV3).

In this embodiment, the field F4 is given as an example for description. For generalization, step S902 receives a sampled CVBS signal corresponding to a field Fi+4, where i is a positive integer. In the other steps, operations can be derived from the corresponding fields in the flowchart of FIG. 9, and thus a detailed description is deemed unnecessary.

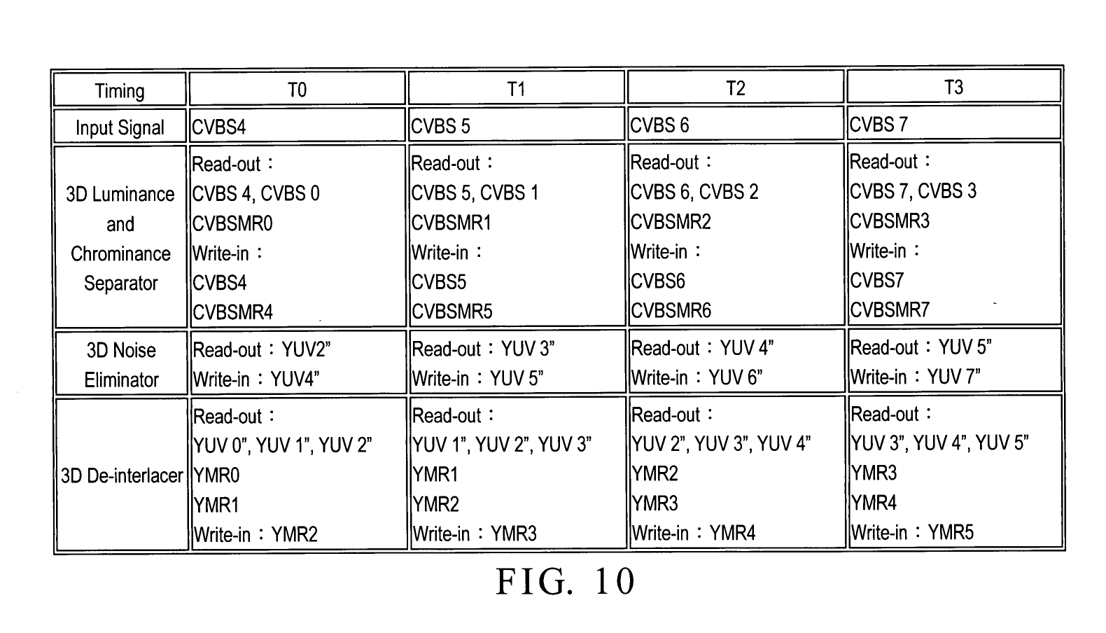

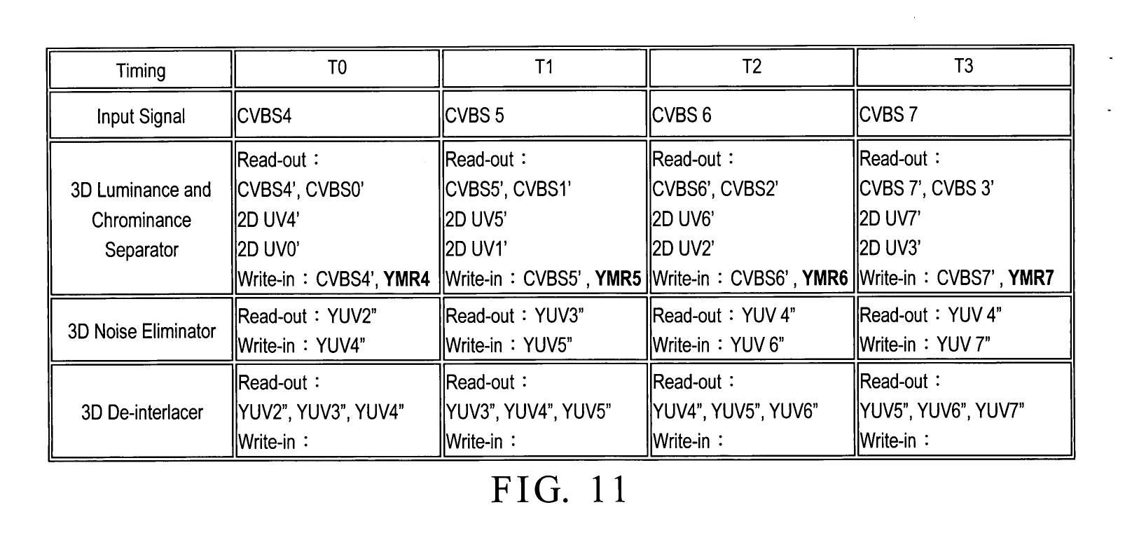

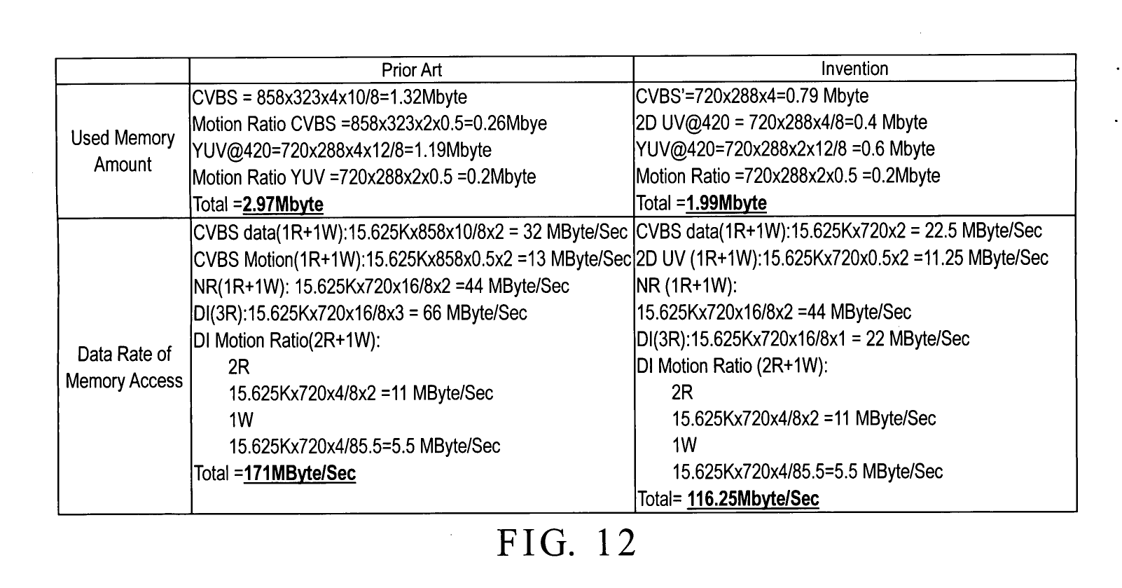

FIG. 10 is a timing diagram of a prior system for decoding and de-interlacing CVBS signal. FIG. 11 is a timing diagram of a system for decoding and de-interlacing CVBS signal in accordance with the invention. FIG. 12 is a comparison table of a storage space used by the prior art and the invention. As shown in FIG. 12, the used memory amount is 1.99M bytes for the invention, and 2.97M bytes for the prior art. The data rate of memory access is 116.25M bytes/sec for the invention, and 171 M bytes/sec for the prior art. For calculating the used memory amount for CVBS signal, it requires higher resolution for decoding the UV signal, and accordingly the prior art uses 10-bit resolution to store the CVBS signal.

As compared with the prior art, the configuration in the invention can reduce the used memory amount by one field at performing the de-interlacing operation. In addition, the motion ratio requires only one copy. The storage 460 temporarily stores the synchronized CVBS signal (CVBS4′) and the synchronized 2D color difference signal (2D UV4′) processed by the synchronization and scaling device 450, which uses the memory amount of 1.19M bytes (0.79M+0.4M). The prior art does not use the synchronization, so it requires the memory amount of 1.32M bytes, which is more than that of the invention.

As cited, as compared with the prior art, the invention not only can reduce the used memory amount, but also can decrease the data rate of memory access, so as to lower the bandwidth of memory access and the entire system clock frequency, thereby reducing the entire system power consumption.

Although the present invention has been explained in relation to its preferred embodiment, it is to be understood that many other possible modifications and variations can be made without departing from the spirit and scope of the invention as hereinafter claimed.

What is claimed is:

1. A system for decoding and de-interlacing CVBS signal, comprising:
a 2D luminance and chrominance separator for receiving a sampled CVBS signal corresponding to a field, and extracting a 2D luminance signal and a 2D chrominance signal from the sampled CVBS signal;
a chrominance to color difference converter connected to the 2D luminance and chrominance separator for converting the 2D chrominance signal into a 2D color difference signal;
a synchronization and scaling device connected to the 2D luminance and chrominance separator and the chrominance to color difference converter for receiving the sampled CVBS signal and performing a synchronization operation on the sampled CVBS signal, the 2D luminance signal, and the 2D color difference signal to generate a synchronized CVBS signal, a synchronized 2D luminance signal, and a synchronized 2D color difference signal, respectively;
a storage connected to the synchronization and scaling device for temporarily storing the synchronized CVBS signal, the synchronized 2D luminance signal, and the synchronized 2D color difference signal; and
a 3D luminance and chrominance separation, de-noise and de-interlacing device connected to the synchronization and scaling device and the storage for performing a 3D luminance and chrominance separation, de-noise and de-interlacing operation to generate a frame.

2. The system as claimed in claim 1, further comprising an analog to digital converter (ADC) for receiving and sampling an analog CVBS signal, and converting the analog CVBS signal into a digital CVBS signal so as to generate the sampled CVBS signal.

3. The system as claimed in claim 2, wherein the 3D luminance and chrominance separation, de-noise and de-interlacing device comprises:
a 3D luminance and chrominance separator connected to the synchronization and scaling device and the storage for receiving the synchronized CVBS signal and the synchronized 2D color difference signal outputted by the synchronization and scaling device, and a previous synchronized CVBS signal and a previous synchronized 2D color difference signal stored in the storage, performing a 3D luminance and chrominance separation operation on the synchronized CVBS signal to produce a 3D luminance signal, and performing an average operation on the synchronized 2D color difference signal and the previous synchronized 2D color difference signal to produce a 3D color difference signal, wherein the synchronization and scaling device stores the synchronized CVBS signal into the storage;
a mixer connected to the synchronization and scaling device and the 3D luminance and chrominance separator for mixing the synchronized 2D luminance signal, the synchronized 2D color difference signal, the 3D luminance signal, and the 3D color difference signal based on a motion ratio so as to generate a mixed field signal;
a noise eliminator connected to the mixer and the storage for performing a de-noise operation based on the mixed field signal outputted by the mixer and a previous mixed field signal stored in the storage to generate a de-noise field signal; and
a de-interlacer connected to the 3D luminance and chrominance separator, the noise eliminator, and the storage for performing a de-interlacing operation based on the de-noise field signal outputted by the noise eliminator and a previous de-noise field signal stored in the storage so as to generate a de-interlaced frame signal.

4. The system as claimed in claim 3, wherein the 3D luminance and chrominance separator includes a motion detector connected to the synchronization and scaling device, the noise eliminator, and the de-interlacer for producing the motion ratio based on the synchronized CVBS signal outputted by the synchronization and scaling device, the 3D luminance signal, and the 3D color difference signal.

5. The system as claimed in claim 4, wherein the de-interlacer performs the de-interlacing operation based on the motion ratio, the de-noise field signal, and the previous de-noise field signal.

6. The system as claimed in claim 5, further comprising a line buffer connected to the ADC and the 2D luminance and chrominance separator for temporarily storing the sampled CVBS signal.

7. The system as claimed in claim 6, wherein the line buffer and the storage are integrated into a single memory.

8. A method for decoding and de-interlacing CVBS signal comprising the steps of:
(A) receiving a sampled CVBS signal corresponding to a field;
(B) using a 2D luminance and chrominance separator to extract a 2D luminance signal and a 2D chrominance signal from the sampled CVBS signal;
(C) using a chrominance to color difference converter to convert the 2D chrominance signal into a 2D color difference signal;
(D) using a synchronization and scaling device to perform a synchronization operation on the sampled CVBS signal, the 2D luminance signal, and the 2D color difference signal for generating a synchronized CVBS signal, a synchronized 2D luminance signal, and a synchronized 2D color difference signal, respectively;
(E) using a 3D luminance and chrominance separator to separate and generate a 3D luminance signal and a 3D color difference signal based on the synchronized CVBS signal, the synchronized 2D color difference signal, and a previous synchronized CVBS signal;
(F) using a mixer to mix the synchronized 2D luminance signal, the synchronized 2D color difference signal, the 3D luminance signal, and the 3D color difference signal based on a motion ratio to generate a mixed field signal;
(G) using a noise eliminator to perform a de-noise operation based on the mixed field signal and a previous mixed field signal to generate a de-noise field signal; and
(H) using a de-interlacer to perform a de-interlacing operation based on the de-noise field signal and a previous de-noise field signal to generate a de-interlaced frame.

9. The method as claimed in claim 8, wherein the step (A) further includes: using an ADC to receive and sample an analog CVBS signal for converting the analog CVBS signal into a digital CVBS signal so as to thereby produce the sampled CVBS signal.

10. The method as claimed in claim 9, wherein the step (E) further includes: using a motion detector to produce the motion ratio based on the synchronized CVBS signal, the 3D luminance signal, and the 3D color difference signal.

11. The method as claimed in claim 10, wherein the step (A) receives a sampled CVBS signal corresponding to an (i+4)-th field, and the 2D luminance and chrominance separator in the step (B) extracts a 2D luminance signal and a 2D chrominance signal from the sampled CVBS signal corresponding to the (i+4)-th field, where i is a positive integer.

12. The method as claimed in claim 10, wherein the chrominance to color difference converter in the step (C) converts the 2D chrominance signal into a 2D color difference signal for the (i+4)-th field, and the synchronization and scaling device in the step (D) performs a synchronization operation on the sampled CVBS signal, the 2D luminance signal, and the 2D color difference signal for generating a synchronized CVBS signal, a synchronized 2D luminance signal, and a synchronized 2D color difference signal, respectively, for the (i+4)-th field.

13. The method as claimed in claim 12, wherein the 3D luminance and chrominance separator in the step (E) is based on the synchronized CVBS signal of the (i+4)-th field and a previous synchronized CVBS signal of an i-th field to separate and generate a 3D luminance signal and a 3D color difference signal for the (i+4)-th field.

14. The method as claimed in claim 13, wherein the mixer in the step (F) is based on a motion ratio to mix the synchronized 2D luminance signal, the synchronized 2D chrominance signal, the 3D luminance signal, and the 3D color difference signal so as to generate a mixed field signal, for the (i+4)-th field.

15. The method as claimed in claim 14, wherein the noise eliminator in the step (G) is based on the mixed field signal of the (i+4)-th field and a previous mixed field signal of an (i+2)-th field to perform a de-noise operation so as to generate a de-noise field signal for the (i+4)-th field.

16. The method as claimed in claim 15, wherein the de-interlacer in the step (H) is based on the de-noise field signal of the (i+4)-th field, a previous de-noise field signal of an (i+3)-th field, and a previous de-noise field signal of the (i+2)-th field to perform a de-interlacing operation so as to generate a de-interlaced frame signal for the (i+3)-th field.
